(19) United States
(12) Patent Application Publication
(10) Pub. No.: US 2002/0138832 A1
(43) Pub. Date: Sep. 26, 2002

(54) System for distributing and showing multimedia advertising in theatres and method of operation thereof

(76) Inventor: Michael D. Svoboda, Vinton, IA (US)

Correspondence Address: HITT GAINES & BOISBRUN P.C., P.O. BOX 832570, RICHARDSON, TX, 75083, US

(21) Appl. No.: 09/816,262

(22) Filed: Mar. 23, 2001

(51) Int. Cl. H04N 7/10

(52) U.S. Cl. 725/36; 725/32

(57) ABSTRACT

A system for, and method of, distributing and displaying advertising in theaters. In one embodiment, the system includes: (1) an advertising server having a database of advertisements, (2) a plurality of geographically distributed displays, associated with a corresponding plurality of theatres and coupled via a network to the advertising server and (3) a distribution controller, associated with the advertising server, that causes selected ones of the advertisements to be communicated from the advertising server via the network and displayed in the theatres on the plurality of displays.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyrights whatsoever.

### TECHNICAL FIELD OF THE INVENTION

The present invention is directed, in general, to a advertising distribution system and, more specifically, to a system for distributing advertising to movie theatres and showing such advertising to the theatre's patrons and a method of operating such system.

### BACKGROUND OF THE INVENTION

The movie industry is divided economically into the three general areas, or phases, of production, distribution and exhibition. The production phase is the actual making of the movie from conception of an idea until the movie is ready for distribution and exhibition. As can be anticipated, the production phase absorbs the majority of the cost and expense incurred in making a movie. Production expense includes such items as location or sound stage costs, costuming, lighting, camera work, salaries of the people working on and in support of the movie, as well as numerous other items.

The distribution phase includes such items as the advertising and promotion of the movie in order to generate public interest so people will pay to see the movie, selection of theatres in which the movie will be shown, negotiation of agreements with the selected theatres, distribution of prints to the theatres, and other similar tasks. The distribution phase also represents a significant cash outlay. Until such time as the print of a movie is actually in a theatre ready for exhibition, a movie's cash flow is all negative.

Control of the production and distribution phases of a movie is generally centralized in the hands of a single corporate entity. Only in a very limited number of cases will an entity that controls production and distribution also control exhibition. On the other hand, control of the exhibition phase of a movie is very fragmented. Some exhibitors may own a single movie theatre while other exhibitors may own a number of theatres or a chain of theatres. Notwithstanding the fact that certain exhibitors may own a significant number of theatres, overall the ownership is sufficiently diverse so that no single owner is in a position to dictate terms pursuant to which a particular movie will be shown in particular theatres.

As a general rule, exhibition of a newly released movie will commence on the same date in several hundred theatres across the country. If a particular movie is deemed to be a hot property, the competition between and among the various movie theatres for the right to exhibit that movie becomes intense. The competition for product means sellers of the product, the production and distribution segments of the movie industry, can dictate terms to theatre owners. In most cases, if not all, one-hundred percent of the amount received from the public as admission to the movie goes to the selling entity.

If revenue generated from admissions goes to the production and distribution entity or entities, this means owners and managers of theatres must look for other revenue sources in order to keep the theatre open. One obvious source of theatre revenue is the concession stand. Another source of revenue is advertising, ranging from posters in the lobby to advertisements shown on the movie screen prior to the main attraction. Movie patrons are now accustomed to going to a movie and viewing a series of advertisements, generally in a slide presentation format, prior to the previews of coming attractions and the feature.

The advertising mix in the slide presentation shown prior to a movie is drawn predominantly from local businesses. In an attempt to keep the attention of the audience, the slide presentation may mix in movie trivia as well as community service features, particularly in smaller communities. For example, the advertisements may consist of a series of ads from local businesses, such as insurance agencies and local automobile dealerships, with topics of local or community interest interspersed among the slides, such as information about a fund drive for the local volunteer fire department.

Although amounts received by the theatre owner for such advertising may be quite modest, it is still an important source of revenue because it does not have to be shared with the production and distribution entities and the majority drops to the theatre's bottom line as profit. The modest amount of revenue generated, however, means that the amount of time and effort that can be justifiably expended to secure and present such advertisements is limited. By the same token, the amount justifiably invested in equipment to show the ads is also limited. This is why virtually all on-screen advertisements shown in movie theatres consist of 1slide presentations. The revenue generated simply does not justify the expense of using any media other than slides. Slide projection equipment is relatively inexpensive and the cost of slides is quite economical. If an alternative system to show and distribute advertisements were available, the amount of revenue to the theatre owner could be significantly increased relative to the revenue generated using prior art systems.

Accordingly, what is needed in the art is a system for distributing advertising to movie theatres and showing such advertising to the theatre's patrons and a method of operating such system.

### SUMMARY OF THE INVENTION

To address the above-discussed deficiencies of the prior art, the present invention provides a system for, and method of, distributing and displaying advertising in theatres. In one embodiment, the system includes: (1) an advertising server having a database of advertisements, (2) a plurality of geographically distributed displays, associated with a corresponding plurality of theatres and coupled via a network to the advertising server and (3) a distribution controller, associated with the advertising server, that causes selected ones of the advertisements to be communicated from the advertising server via the network and displayed in the theatres on the plurality of displays.

Thus the present invention provides a system that uses a network to distribute advertizing to movie theatres for viewing by patrons of the theatre. The system permits the advertising presentation to be updated by the addition or removal of ads or announcements on-line and virtually instantaneously. The system also permits ads to be presented to theatre patrons in a multi-media format.

In one embodiment of the present invention, the plurality of displays include video projectors adapted to display advertisements on corresponding movie screens of the theatres. An aspect of this embodiment provides that the plurality of displays includes video monitors adapted to display advertisements in common areas of the theatres.

In another embodiment of the present invention, the advertisements are selected from the group consisting of: (1) static, (2) picture-in-picture, (3) audio, (4) animation, (5) multi-segment and (6) full-motion video clips. In another embodiment, the plurality of geographically distributed displays each include a local storage unit that locally stores the selected ones of the advertisements.

In a particularly useful embodiment of the present invention, the distribution controller includes a reporting module that maintains a distribution history for the selected ones of the advertisements. This embodiment provides useful data to help sell and price advertisements. In yet another embodiment of the present invention, the distribution controller includes a copy module that allows remote advertisers to provide new advertisements to the database. In an additional embodiment of the present invention, the advertising controller causes the selected ones of the advertisements to be communicated from the advertising server based on: (1) time of day, (2) day of week, (3) season, (4) movie screen sizes in the theatres and (5) ratings of motion pictures playing in the theatres.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic presentation of an embodiment, in block diagram form, of a system for distributing and displaying advertising in theatres;

FIGS. 2A-2S consist of a series of screen shots of a sample movie theatre advertising exhibition for the purpose of illustrating the beneficial aspects of the present invention; and

FIG. 3 illustrates a schematic diagram of a flow chart of an embodiment of a method of distributing and displaying advertising in theatres in accordance with the present invention.

### DETAILED DESCRIPTION

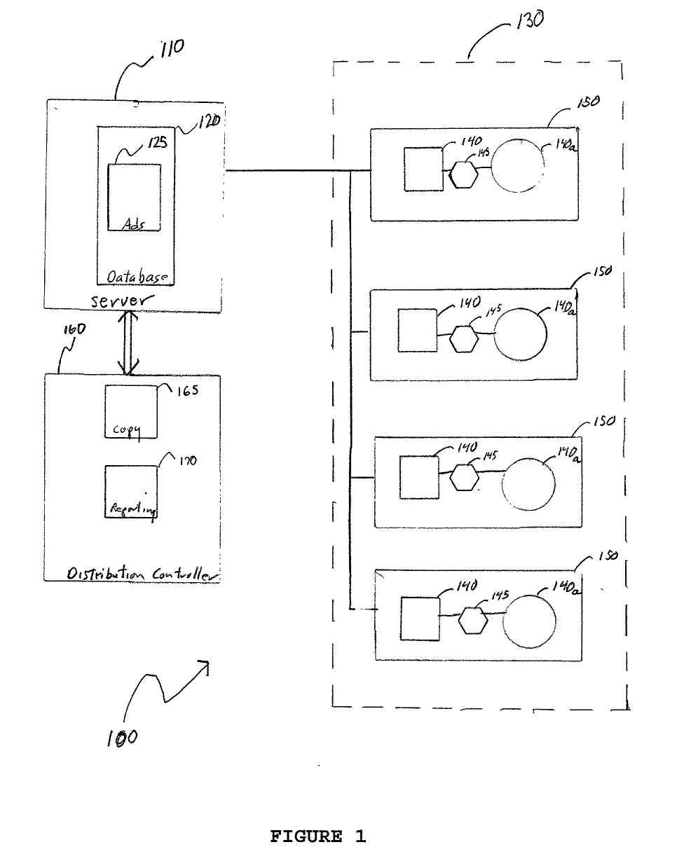

Referring initially to FIG. 1, illustrated is a schematic presentation of an embodiment, in block diagram form, of a system 100 for distributing and displaying advertising in theatres. The illustrated system 100 includes an advertising server 110 with a database 120 of advertisements 125. The database 120 can include both local and national advertisements 125 as well as advertisements 125 for paid and unpaid advertisers. Unpaid advertising copy included in the database 120 would most probably be included for community service purposes, such as advertisements 125 promoting local athletic teams or charitable organizations.

Coupled to the advertising server 110, via a network 130, are a plurality of geographically distributed displays 140 associated with a corresponding plurality of theatres 150. Although FIG. 1 shows only four theatres 150 for illustration purposes, those of ordinary skill in the pertinent art will recognize that any number of theatres 150 connected via a network 130 are within the intended scope of the present invention as are any number of displays 140 at such theatres 150.

The system has a distribution controller 160, associated with the advertising server 110, that causes selected ones of the advertisements 125 to be communicated from the advertising server 110 via the network 130 and displayed on the plurality of displays 140 in the theatres 150. Thus, the invention provides a system 100 for advantageously distributing, via a network 130, advertisements 125 for exhibition on displays 140 associated with movie theatres 150. A special benefit of the system 100 is that it provides a system to economically and instantaneously update and distribute advertisements 125 to theatres 150 for exhibition.

Movie-goers expect, preliminary to the main feature, an exhibition of a series of advertisements 125 presented in a slide format, perhaps with a musical background. It is also fair to characterize advertising presented using a slide format as a generally boring experience that must be endured until the previews of coming attractions start. One reason audience interest picks up when the previews start, is that the previews are presented in an interesting format. A beneficial aspect of the present invention permits advertisements 125 to be economically distributed and exhibited in a multi-media format that is of interest to the audience. If movie patrons are paying more attention to the advertising, it also may makes it easier to sell advertising to local businesses at a larger fee.

In one embodiment of the invention, the plurality of displays 140 associated with the theatres 150, include video projectors adapted to display advertisements 125 on corresponding movie screens. This embodiment permits the exhibition of advertisements 125 in a multi-media format. Another embodiment of the invention provides for video monitors 140a to be used in the plurality of displays. Video monitor 140a displays can be adapted to display advertisements 125 in common areas of the theatres 150 and, thus, increase audience exposure to the advertisements 125. For example, video monitors 140a in the lobby can be viewed by people waiting for admission to a feature film when the prior showing of such film is still in progress. Similarly, video monitors 140a near the concession stand can be viewed by customers waiting for service. By providing more opportunities for people to see advertisements 125 it makes it easier for a theatre to sell advertisements.

A particularly attractive aspect of one embodiment of the invention permits advertisements to be selected from the group consisting of: (1) static, (2) picture-in-picture, (3) audio, (4) animation, multi-segment and (6) full-motion video clips. Of course, those of ordinary skill in the pertinent art will understand that any medium, or combination of mediums, used to exhibit or present an advertisement 125 is well within the intended scope of the present invention. As previously indicated, the multi-media presentation aspect of the present invention serves to increase the value of theatre 150 advertising 125 to both theatre 150 owners and theatre 150 advertisers.

The economics and character of theatre advertising means that local businesses will be an important source of a substantial amount of advertising business for local theatres 150. A particularly useful embodiment of the invention provides for the plurality of geographically distributed displays 140 to each include a local storage unit 145 that locally stores selected ones of the advertisements 125. An advantage of such an embodiment is that it permits a local theatre to immediately add advertising copy to the displays 140, 140a. This embodiment also provides a competitive advantage to a movie theatre 150 that has the embodiment over one that does not. Those of ordinary skill in the pertinent art will understand that this embodiment can extend to a theatre 150 having multiple displays 140, 140a and to a geographic area having multiple theatres 150, each of which may, or may not, have multiple displays 140, 140a.

Although a substantial amount of advertising displayed in a movie theatre 150 is local in nature, some advertisements 125 are shown as part of a nationwide campaign for a particular business. For example, an advertising campaign by an automobile manufacturer may have advertisements 125 for use nationally, even if when shown locally, the expectation is that only the local dealer will benefit. A particularly useful embodiment of the invention provides for the distribution controller 160 to include a copy module 165 that allows remote advertisers to provide new advertisements 125 to the database. Thus, an automobile manufacturer can provide new advertisements to a centralized copy module 165 and the controller 160 can direct the distribution of such advertisement 125 to those remote local locations where the manufacturer has dealers. This embodiment is also useful in those instances where an advertiser has more than one business location and wants to run the same advertisement 125 in a theatre 150 at each local location. Another instance where such an embodiment is useful is when the local business has its advertising material prepared in a different geographic locality. The party preparing the advertisement 125 can input a completed advertisement 125 in the copy module 165 and the controller 160 can direct it to the appropriate advertising location. Those of ordinary skill in the pertinent art will understand that other circumstances may be appropriate for using an embodiment of the invention including a copy module 165, all of which are within the intended scope of the present invention.

Another particularly useful embodiment of the invention provides for the distribution controller 160 to cause the selected ones of the advertisements 125 to be communicated from the advertising server 110 based on: (1) time of day, (2) day of week, (3) season, (4) movie screen sizes in the theatres and (5) ratings of motion pictures playing in the theatres. Among other things, this permits advertisements 125 to be distributed over the network for display at movie theatres 150 based on the type of audience expected for particular movie. For example, a movie feature expected to appeal to families with children can display advertisements 125 directed to this type of audience, such as an automotive advertisement 125 that features vans or family vehicles. An action movie, on the other hand, may use an automotive advertisement that features light trucks or sport utility vehicles.

In another embodiment of the invention, the distribution controller 160 includes a reporting module 170 that maintains a distribution history for the selected ones of the advertisements 125. The kind or type of distribution history maintained can include information such as the number of times an advertisement 125 is displayed, the time of each display, and the number of people estimated to observe the display. This type of information is invaluable to theatre owners selling advertisements 125 as well as the purchasing advertiser.

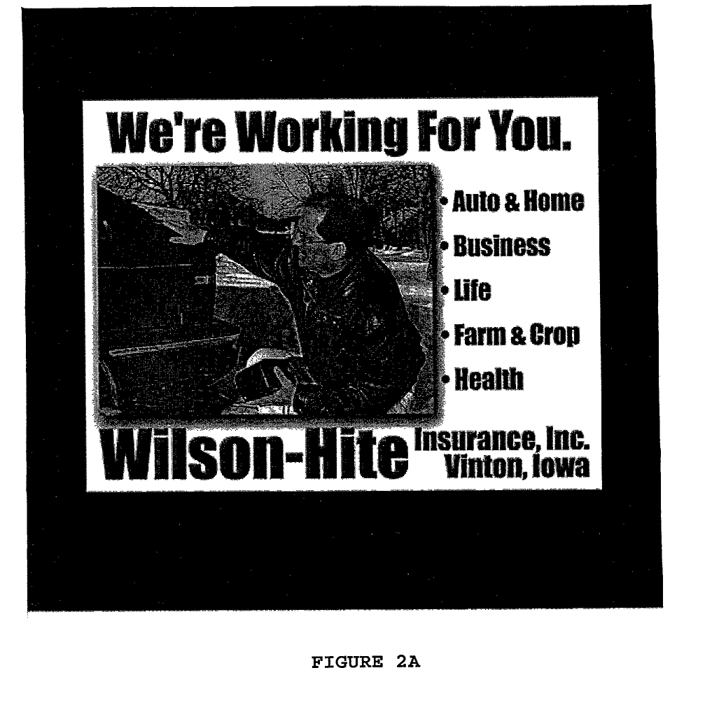

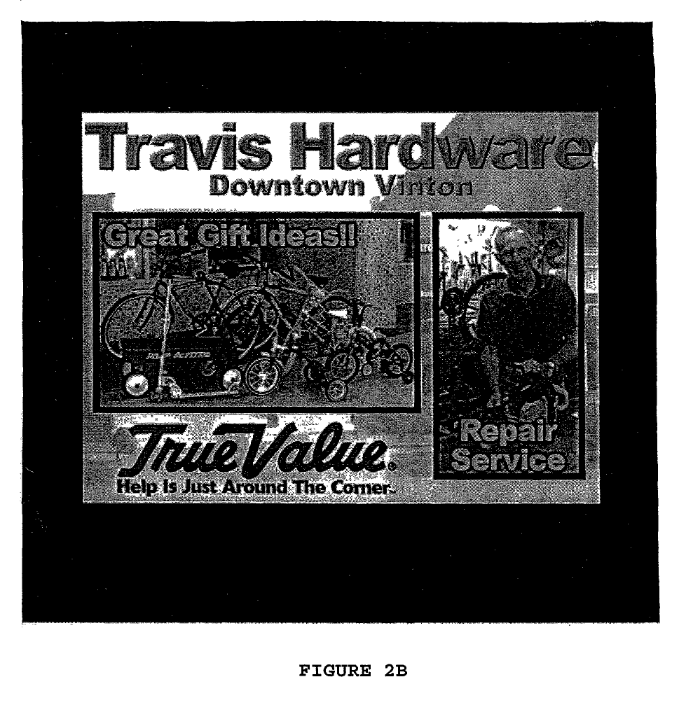

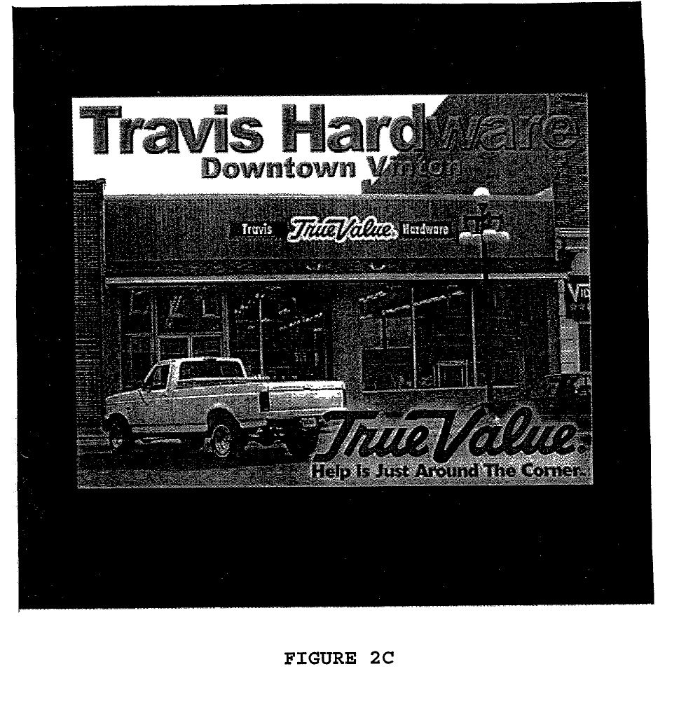

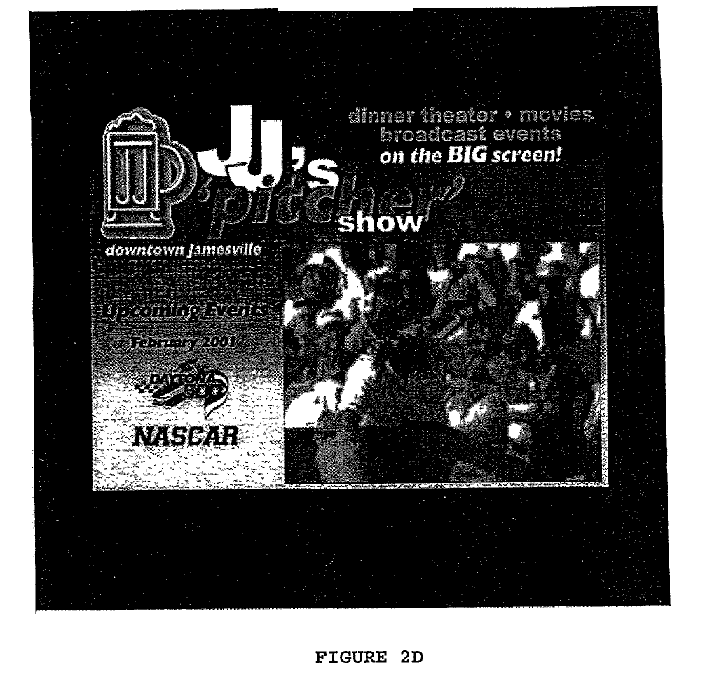

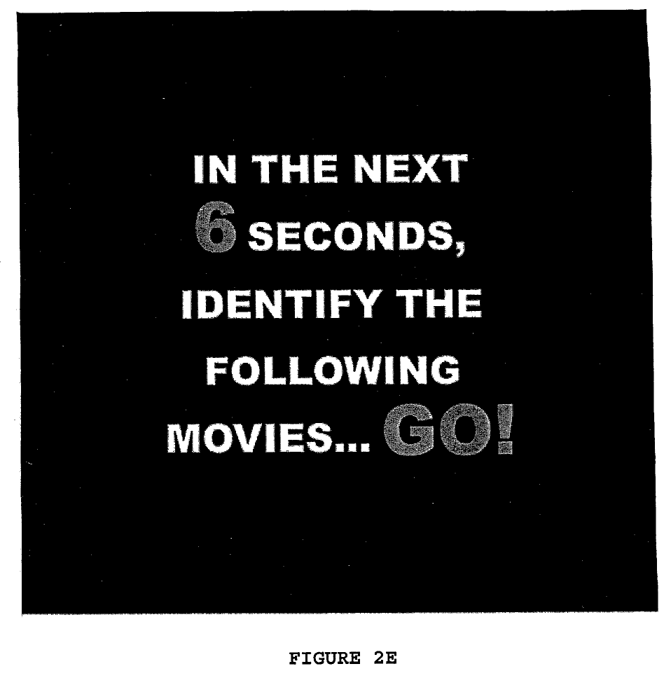

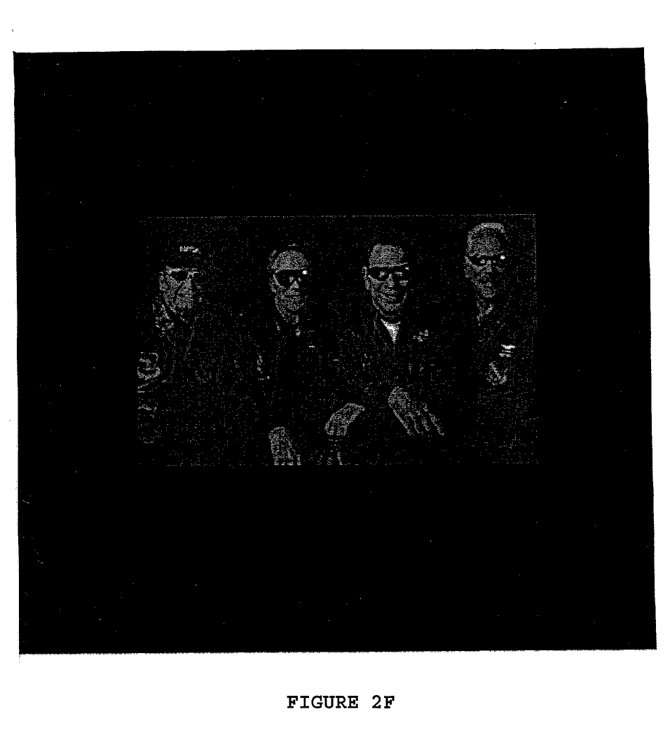

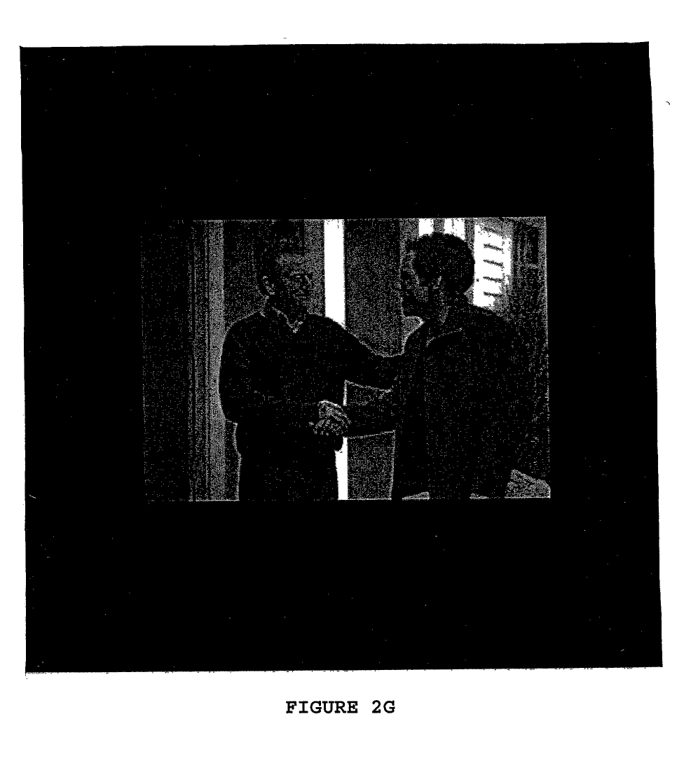

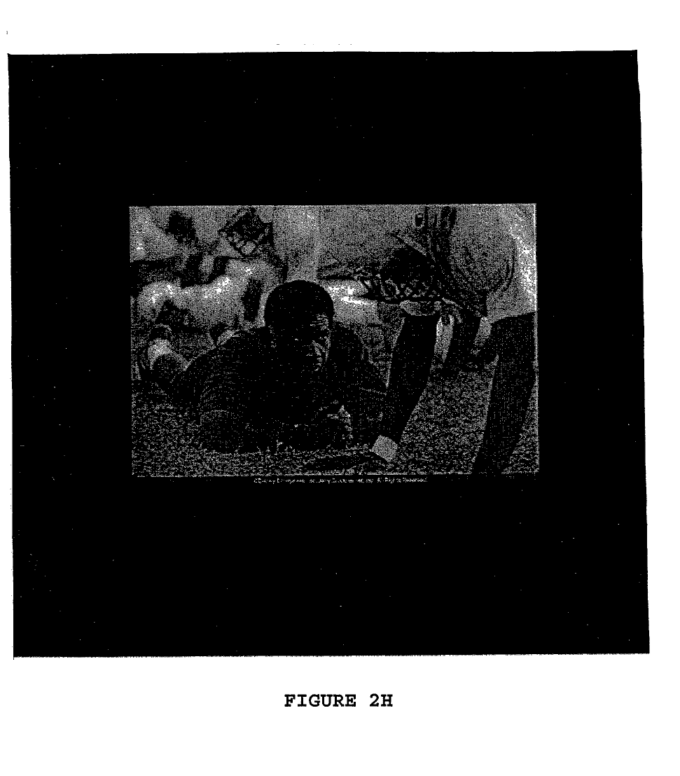

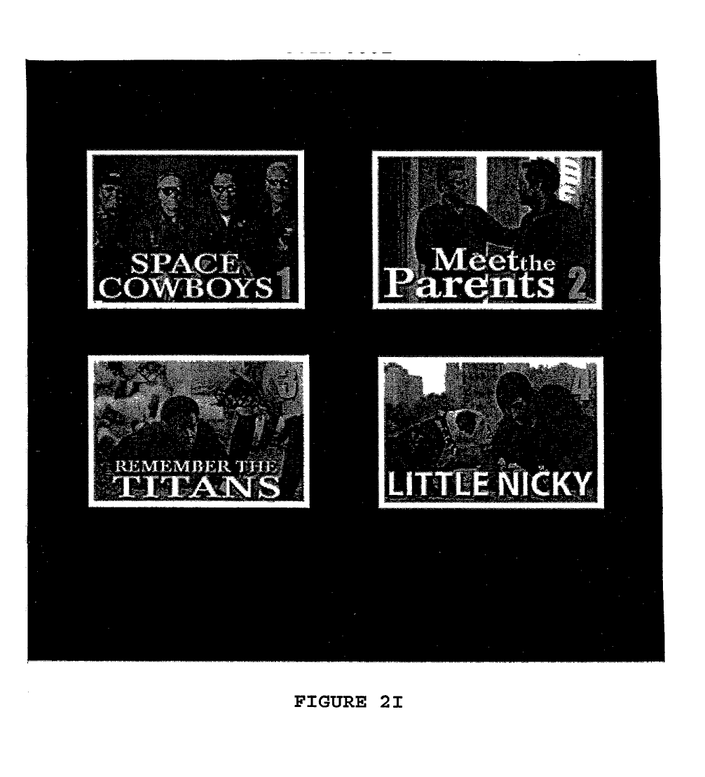

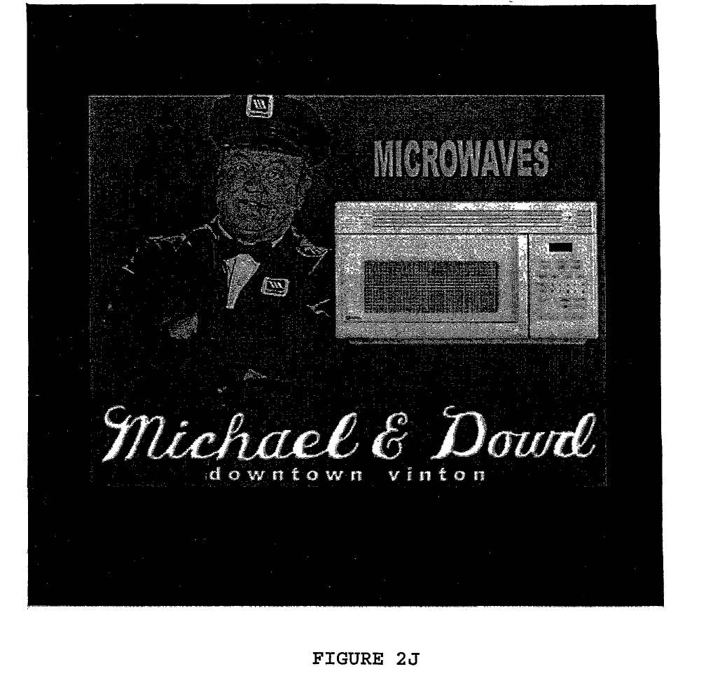

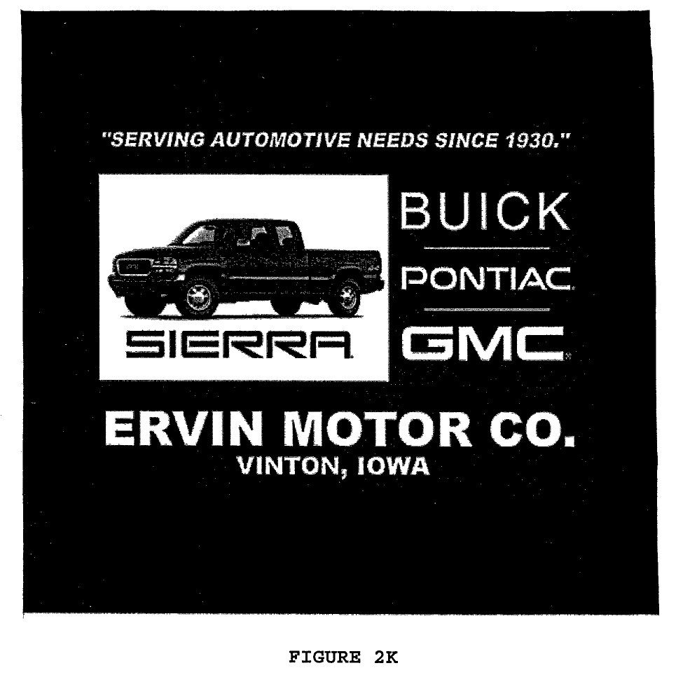

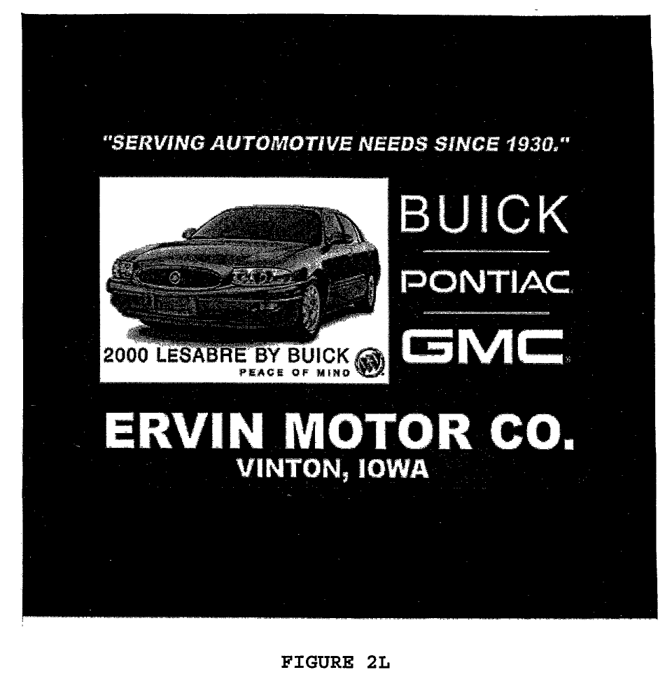

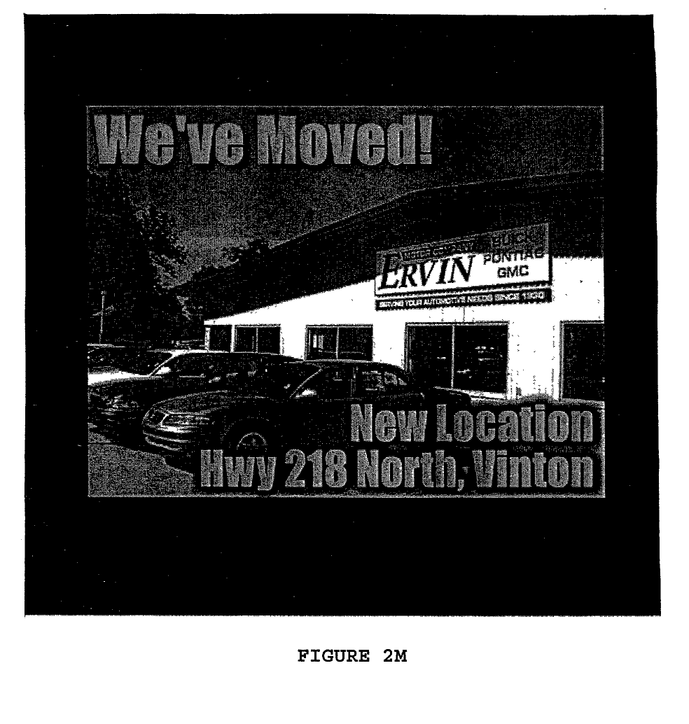

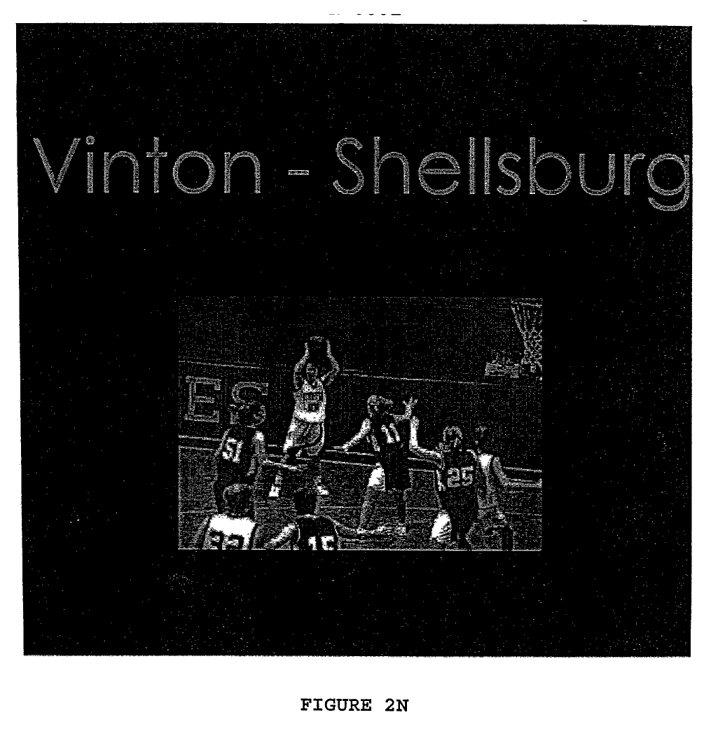

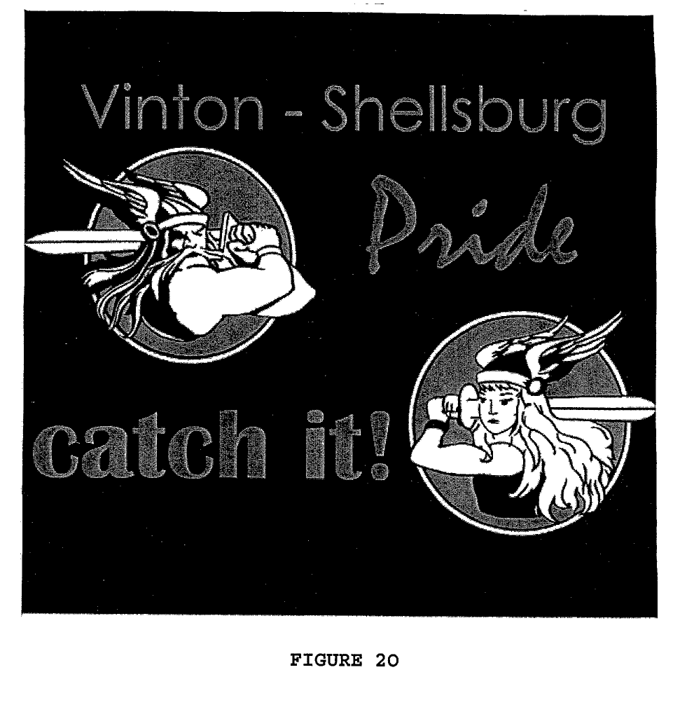

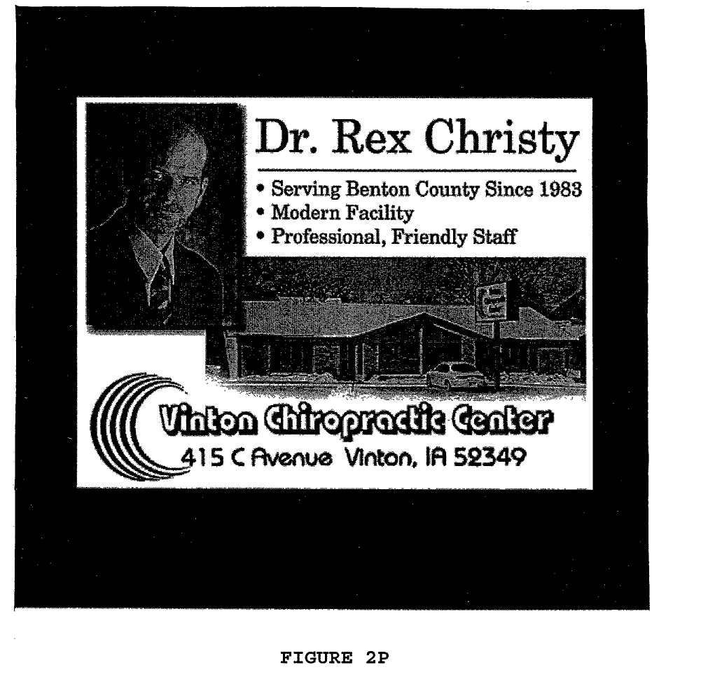

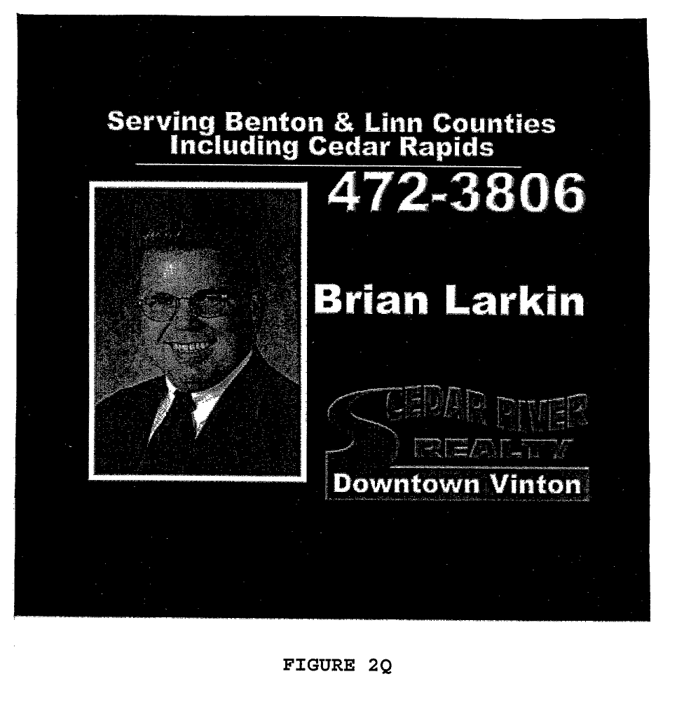

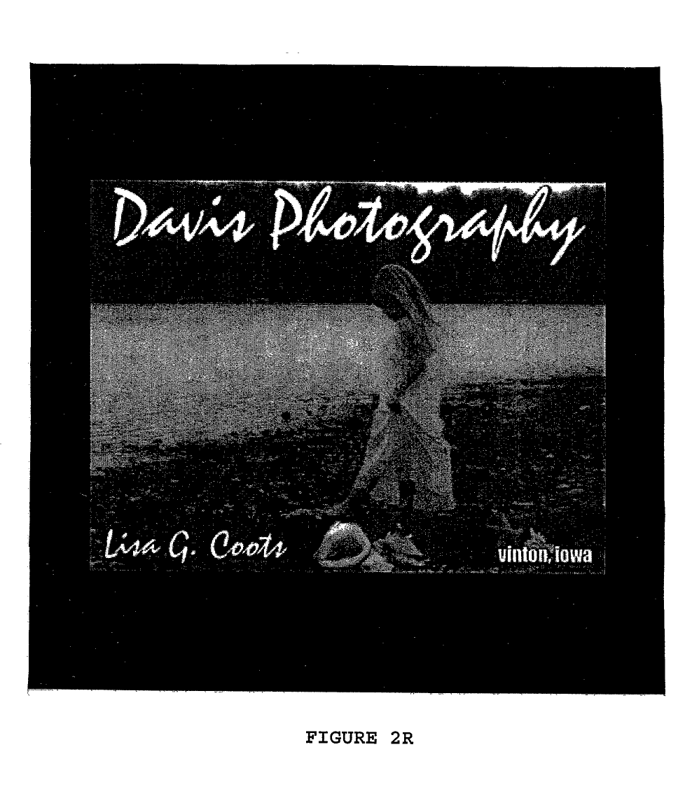

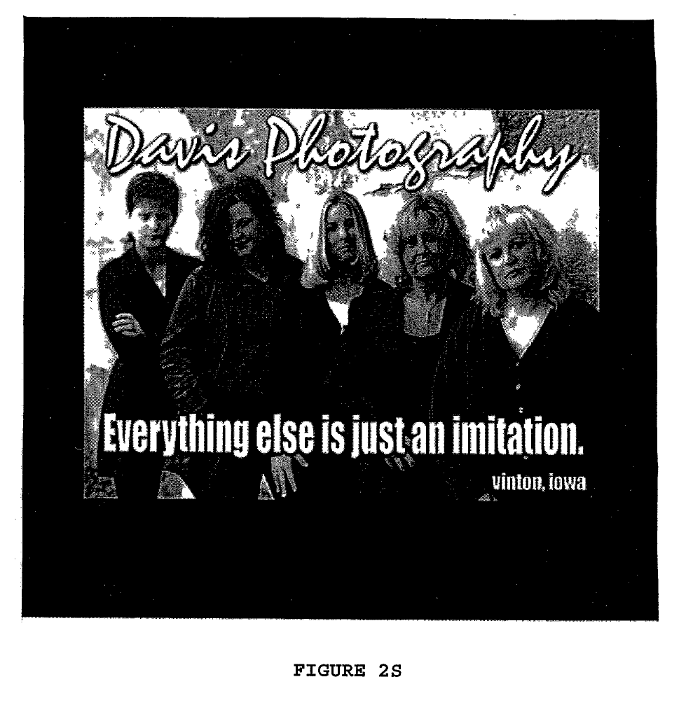

Turning now to FIGS. 2A-2S illustrated is a series of screen shots of a sample movie theatre advertising exhibition presented for the purpose of illustrating the beneficial aspects of the present invention. FIG. 2A illustrates an advertisement for the type of business that would typically advertise in the local theatre. In this case, it is a local insurance agency doing business in Vinton, Iowa, where the theatre is located. FIGS. 2B and 2C show another local business in Vinton, Iowa. In this case it is a local hardware store that has the nationally known brand of being a True Value© hardware store. The invention can be particularly useful in this instance because True Value© can provide new copy to be used by its local affiliates.

Turning to FIG. 2D, a local sports bar is advertising a forthcoming event that it plans to show. The invention permits the use of a multi-media video presentation depicting a NASCAR© race in the lower right corner of the advertisement. The sports bar hopes to attract customers to its place of business when the forthcoming race is run but, once the race is completed, the sports bar must change its presentation to highlight another forthcoming event. If the local theatre has an embodiment of the invention that includes a local storage unit, representative films of events such as football and baseball games can be stored and called up for display as needed.

In order to keep the movie goer's interest, a short movie trivia quiz is presented. FIGS. 2E through 2I are screen shots of a portion of the trivia quiz and the answers. Following the trivia quiz, another local advertisement is shown. FIG. 2J shows a screen shot from the advertisement, which is a parody of the familiar Maytag© repairman. In the next series of ads, FIGS. 2K-2M, advertisements for a local automobile dealership are presented. With the appropriate embodiment of the invention, as previously discussed, different kinds of vehicles can be emphasized for different audiences. Another beneficial aspect of the present invention is illustrated in FIG. 2M, where an new business location is being announced. This kind of announcement can be immediately instituted using the appropriate embodiment of the present invention and immediately distributed over the network to displays at theatres in the dealership's geographic area of interest.

In order to promote community relations and civic pride, a video of a local girls athletic team is inserted in the display. FIGS. 2N-2O are screen shots of the Vinton-Shellsburg high school girls basketball team. In FIG. 2M an action shot is shown of a player making a basket and then, in a series of shots leading up to FIG. 2N, school spirit is promoted. This kind of advertising display is of particular importance to small local community theatres in order to demonstrate civic commitment. In addition, it is good advertising for the theatre itself because the local students are generally important theatre customers.

FIGS. 2P through 2S continue the advertising display by showing more local business advertisements. The importance and usefulness of the present invention will be readily apparent to one of ordinary skill in the pertinent art. The invention permits theatre owners to successfully and efficiently exploit a revenue stream. This revenue stream is important because the largest portion of such revenue falls directly to the theatre's bottom line.

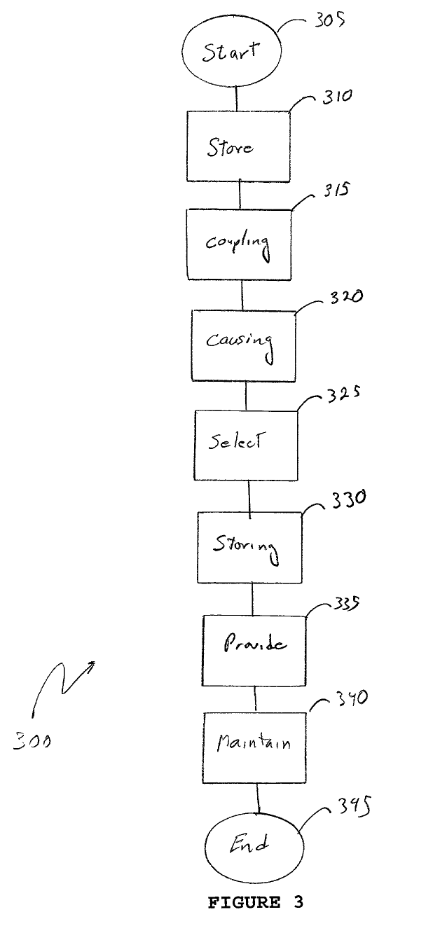

Turning now to FIG. 3, a schematic diagram of a flow chart illustrating an embodiment of a method 300 of distributing and displaying advertising in theatres. The method commences with a start step 305. In a store step 310, a plurality of advertisements is stored in a database of advertisements associated with an advertising server. In a coupling step 315, a plurality of geographically distributed displays, associated with a corresponding plurality of theatres, is coupled to the advertising server via a network. In a causing step 320, selected ones of the advertisements are caused to be communicated from the advertising server via the network and displayed in theatres on a plurality of displays.

In one embodiment, the plurality of displays include video projectors adapted to display advertisements on corresponding movie screens of the theatres. The method 300 may include an embodiment wherein the plurality of displays include video monitors adapted to display advertisements in common areas of the theatres. Another embodiment of the method 300 provides for a select step 325 to be included, wherein advertisements are selected from the group consisting of static, picture-in-picture, audio, animation, multi-segment and full-motion video clips.

In another embodiment of the method 300, the plurality of geographically distributed displays each comprise a local storage unit, and a storing step 330 is provided for locally storing selected ones of the advertisements. In still another embodiment, a provide step 335 is included to allow remote advertisers to provide new advertisements to the database. A useful embodiment may further include a maintain step 340, wherein a distribution history for the selected ones of the advertisements is maintained. The method 300 concludes with an end step 340.

Although the present invention has been described in detail, those skilled in the art should understand that they can make various changes, substitutions and alterations herein without departing from the spirit and scope of the invention in its broadest form.

What is claimed is:

1. A system for distributing and displaying advertising in theatres, comprising:
an advertising server having a database of advertisements;
a plurality of geographically distributed displays, associated with a corresponding plurality of theatres and coupled via a network to said advertising server; and
a distribution controller, associated with said advertising server, that causes selected ones of said advertisements to be communicated from said advertising server via said network and displayed in said theatres on said plurality of displays.

2. The system as recited in claim 1 wherein said plurality of displays include video projectors adapted to display advertisements on corresponding movie screens of said theatres.

3. The system as recited in claim 1 wherein said plurality of displays include video monitors adapted to display advertisements in common areas of said theatres.

4. The system as recited in claim 1 wherein said advertisements are selected from the group consisting of:
static,
picture-in-picture,
audio,
animation,
multi-segment, and
full-motion video clips.

5. The system as recited in claim 1 wherein said plurality of geographically distributed displays each comprise a local storage unit that locally stores said selected ones of said advertisements.

6. The system as recited in claim 1 wherein said distribution controller comprises a reporting module that maintains a distribution history for said selected ones of said advertisements.

7. The system as recited in claim 1 wherein said distribution controller comprises a copy module that allows remote advertisers to provide new advertisements to said database.

8. A method of distributing and displaying advertising in theatres, comprising:
storing a plurality of advertisements in a database of advertisements associated with an advertising server;
coupling a plurality of geographically distributed displays, associated with a corresponding plurality of theatres, to said advertising server via a network; and
causing selected ones of said advertisements to be communicated from said advertising server via said network and displayed in said theatres on said plurality of displays.

9. The method as recited in claim 8 wherein said plurality of displays include video projectors adapted to display advertisements on corresponding movie screens of said theatres.

10. The method as recited in claim 8 wherein said plurality of displays include video monitors adapted to display advertisements in common areas of said theatres.

11. The method as recited in claim 8 wherein said advertisements are selected from the group consisting of:
static,
picture-in-picture,
audio,
animation,
multi-segment, and
full-motion video clips.

12. The method as recited in claim 8 wherein said plurality of geographically distributed displays each comprise a local storage unit, said method further comprising locally storing said selected ones of said advertisements.

13. The method as recited in claim 8 further comprising maintaining a distribution history for said selected ones of said advertisements.

14. The method as recited in claim 8 further comprising allowing remote advertisers to provide new advertisements to said database.

15. A system for distributing and displaying advertising in theatres, comprising:
a computer network;
an advertising server having a database of advertisements and coupled to said computer network;
a plurality of geographically distributed displays, associated with a corresponding plurality of theatres and coupled to said computer network; and
an advertising controller, coupled to said computer network, that:
allows advertisers to provide advertisements to said database,
allows said advertisers to specify distribution of said advertisements among said theatres,
causes selected ones of said advertisements to be communicated from said advertising server via said network and displayed in said theatres on said plurality of displays, and
maintains a distribution history for said selected ones of said advertisements to allow said advertisers to be charged for said distribution.

16. The system as recited in claim 15 wherein said plurality of displays include video projectors adapted to display advertisements on corresponding movie screens of said theatres.

17. The system as recited in claim 15 wherein said plurality of displays include video monitors adapted to display advertisements in common areas of said theatres.

18. The system as recited in claim 15 wherein said advertisements are selected from the group consisting of:
static,
picture-in-picture,
audio,
animation,
multi-segment, and
full-motion video clips.

19. The system as recited in claim 15 wherein said plurality of geographically distributed displays each comprise a local storage unit that locally stores said selected ones of said advertisements.

20. The system as recited in claim 15 wherein said advertising controller causes said selected ones of said advertisements to be communicated from said advertising server based on:
time of day,
day of week,
season,
movie screen sizes in said theatres, and
ratings of motion pictures playing in said theatres.
